(19) United States
(12) Patent Application Publication
(10) Pub. No.: US 2009/0238987 A1
(43) Pub. Date: Sep. 24, 2009

(54) Apparatus for applying electrostatic powders on manufactured articles in general

(76) Inventor: Tito TREVISAN, VERONA (IT)

Correspondence Address: MODIANO & ASSOCIATI, Via Meravigli, 16, MILANO, 20123, IT

(21) Appl. No.: 12/382,376

(22) Filed: Mar. 16, 2009

(30) Foreign Application Priority Data
Mar. 18, 2008 (EP) 08425168.5

(51) Int. Cl. H05H 1/03; B05B 5/03

(52) U.S. Cl. 427/475; 118/621

(57) ABSTRACT

An apparatus for applying electrostatic powders on manufactured articles, comprising at least one dispensing device adapted to dispense gas solid particles mixture having an electrostatic charge, and connected to at least one duct arranged proximate to the surface to be treated and defining a channel for conveying the mixture. The duct has laterally, along its longitudinal extension, at least one passage opening directed toward the surface to be treated. A partition is arranged with at least one of its portions substantially at the passage opening and is permeable to the powder particles. The passage opening and the partition are crossed by force lines of a first electrical field adapted to cause transfer of the powder particles transiting along the conveyance channel on the surface to be treated through the passage opening and the partition.

The present invention relates to an apparatus for applying electrostatic powders on manufactured articles in general.

### BACKGROUND OF THE INVENTION

A method is known for coating manufactured articles in general and metallic profiles for doors and windows in particular, which is based on the use of electrically charged powders transferred to the surface of the part to be coated by means of a stream of air.

This technique is performed commonly by using an apparatus having a coating booth which accommodates internally a plurality of spray guns arranged laterally and at a certain distance from a conveyor of the parts to be coated.

In particular, the spray guns are designed to dispense, by means of a mushroom or V-jet nozzle, a jet which is constituted by a mixture of air and powder toward the parts to be coated which transit in the booth along the conveyor.

Moreover, each spray gun is provided with an electrode which allows to charge electrostatically the dispensed powder particles, at the same time creating an electrostatic field which lies, with its lines of force, in the space in front of the spray guns and closes through the parts that in each instance pass in front of the spray guns.

In order to try to recover the powder particles that are not deposited on the parts during the coating process, air suction is normally applied in the spraying booth at the region where the parts being processed pass, by means of an air collector which is arranged on the opposite side with respect to the spray guns relative to the movement trajectory of the parts to be coated.

With this solution, in practice the powder particles dispensed by the spray guns are transferred proximate to the parts to be coated by the fluid dynamics forces imparted by the spray guns and by the air collector and are deposited on the surface of the parts due to the effect of the electrostatic field generated by the electrodes of the guns.

The drawback of this solution lies mainly in the difficulty in controlling, in the vicinity of the surface of the parts to be coated, the fluid dynamics conditions that allow to provide optimum deposition of the powder particles on the parts to be coated.

If the speed of the air stream that conveys the particles is too high in the vicinity of the part, the fluid dynamics forces that act on the particles in fact tend to prevail on the electrostatic forces, and therefore the powder particles are not influenced by the electrostatic field but are drawn away from the part without being able to deposit on it, consequently causing the presence of coating defects, especially in the regions of the part that lie laterally with respect to the main direction of the air stream. If instead the speed imparted to the powder particles in output from the spray guns is too low, the particles scatter into the surrounding area without even being able to reach the part and thus deposit on its surface.

Moreover, since in current apparatuses the powder particles are freely strewn by the spray guns into the surrounding area, their deposition on the surface of the parts is practically left to chance, and therefore the finer particles, which would allow to improve the graphic definition of the decorations, generally tend to remain suspended in the air and not deposit on the surface of the part, because due to their dimensions they are less subject to the influence of the fluid dynamics and electrostatic forces generated between the spray guns and the parts to be decorated.

### SUMMARY OF THE INVENTION

The aim of the present invention is to provide an apparatus for applying electrostatic powders to manufactured articles in general which is capable of performing a controlled and optimized deposition of the powder particles on the surface of the manufactured article to be treated, so as to obtain a high-quality coating.

Within this aim, an object of the present invention is to provide an apparatus which is capable of giving the greatest assurances of reliability and safety during operation.

Another object of the present invention is to provide an apparatus which is constructively simple and can be obtained easily with low production costs.

This aim and these and other objects which will become better apparent hereinafter are achieved by the apparatus for applying electrostatic powders on manufactured articles in general according to the invention, characterized in that it comprises at least one dispensing device which is adapted to dispense a mixture formed by a gas and by solid particles of powder, at least said solid particles of powder in said mixture having an electrostatic charge, said at least one dispensing device being connected to at least one duct which is arranged proximate to the surface to be treated of a manufactured article and defining a channel for conveying said mixture, said at least one duct having laterally, along its longitudinal extension, at least one passage opening which is directed toward said surface to be treated; a partition being arranged with at least one of its portions substantially at said at least one passage opening, said partition being permeable to said powder particles, said at least one passage opening and said partition being designed to be crossed by the lines of force of at least one first electrical field which is adapted to cause the transfer of said powder particles that transit along said conveyance channel on said surface to be treated through said at least one passage opening and said partition.

### BRIEF DESCRIPTION OF THE DRAWINGS

Further characteristics and advantages of the invention will become better apparent from the description of a preferred but not exclusive embodiment of the apparatus according to the invention, illustrated by way of non-limiting example in the accompanying drawings, wherein:

FIG. 1 is a partial schematic perspective view of the apparatus according to the invention;

FIG. 2 is an enlarged-scale transverse sectional view of the apparatus according to the invention;

FIG. 3 is a transverse sectional view of a second embodiment of the apparatus according to the invention;

FIG. 4 is a general schematic view of a system for feeding the mixture of gas and powder to the apparatus according to the invention;

FIG. 5 is an enlarged-scale schematic longitudinal sectional view of an embodiment of the dispensing device of the apparatus according to the invention;

FIG. 6 is a schematic view of a different embodiment of the apparatus according to the invention;

FIG. 7 is a schematic enlarged-scale sectional view of a detail of the apparatus according to the invention during its operation;

FIG. 8 is a schematic view of a tube which allows to connect the dispensing device and the duct into which the mixture of gas and powder particles is conveyed in the apparatus according to the invention;

FIG. 9 is a schematic side elevation view, shown partly in phantom lines, of the duct of the apparatus according to the invention, illustrating means for varying the distance between a filament arranged inside the conveyance channel defined by the duct and the passage opening of the powder particles;

FIG. 10 is an enlarged-scale view of a detail of FIG. 9;

FIG. 11 shows an embodiment of the duct of the apparatus according to the invention in which means for varying the extent of the opening for the passage of the powder particles are provided;

FIG. 12 is an enlarged-scale view of a detail of FIG. 11;

FIG. 13 is a partially sectional schematic view of a different embodiment of the apparatus according to the invention;

FIG. 14 is a view of a detail of the embodiment of FIG. 13;

FIG. 15 is an enlarged-scale schematic view of a detail of the duct, taken in transverse cross-section, to show the use of an auxiliary partition.

### DESCRIPTION OF THE PREFERRED EMBODIMENTS

With reference to the figures, the apparatus for decorating manufactured articles in general by means of powdered coatings, according to the invention, generally designated by the reference numeral 1, comprises at least one dispensing device 2, which is designed to dispense a substantially uniform mixture 3 composed of a gas, for example air, and solid particles of powder. At least the solid particles of powder of the mixture 3 have an electrostatic charge.

Optionally, both the gas and the powder particles of the mixture 3 can be charged electrostatically.

Conveniently, the gas can also be provided by mixing together several different gases, so as to obtain different composition, density and ionization characteristics according to the requirements.

Preferably, the powder particles have a particle size distribution ranging substantially from 1 μm to 300 82 m and more preferably from 5 μm to 80 μm and are conveniently made of a material which has dielectric characteristics, such as for example a polyester resin.

More preferably, the powder particles are made of a material which can assume an electric charge on the order of 10⁻³ C/kg.

Conveniently, the concentration by volume of the powder particles in the mixture 3 ranges substantially from 0.10 g/dm³ to 20 g/dm³.

As shown, the dispensing device 2 is connected to at least one duct 7, which is arranged proximate to the surface to be treated of a manufactured article 5 and defines a conveyance channel 8 within which the mixture 3 flows.

In particular, along its own longitudinal extension, the duct 7 is provided laterally with at least one passage opening 9, which is directed toward the surface to be treated of the article 5 and can have, for example, a shape which is elongated along a direction which is substantially parallel to the axis of the duct 7 or, according to other possible examples of embodiment, along a direction which is substantially transverse with respect to the extension of the duct 7.

A partition 4, which is permeable to the powder particles and is advantageously made of dielectric material, is arranged substantially at the passage opening 9 with at least one of its portions.

More particularly, the partition 4 is conveniently provided by a plate-like body which is provided with a plurality of through ports 4a which have a controlled dimension, in order to allow the passage, through the partition 4, only of particles of powder which have preset dimensions.

Also according to the invention, the passage opening 9 and the partition 4 are designed to be crossed by the lines of force of at least one first electrical field, which is adapted to act on the powder particles that transit along the conveyance channel 8 and in particular on the particles that pass close to the partition 4, so as to transfer them onto the surface to be treated of the article 5, pushing them through the passage opening 9 and the partition 4.

Advantageously, such first electrical field is generated simply due to the difference in electrical potential that exists between the mass of the mixture 3 that flows through the conveyance channel 8 and the manufactured article 5.

More particularly, the first electrical field in practice can be the result of the sum of two coexisting electrical fields: the electrical field that is established due to the difference in electrical potential between the set of electrically charged powder particles that flow in the conveyance channel 8 and the manufactured article 5, and the electrical field generated due to the difference in electrical potential between the set of free charges or ions that are present in the gas of the mixture 3 and the manufactured article 5.

Advantageously, in order to ensure a more effective transfer of the powder particles onto the surface to be treated of the manufactured article 5, it is also possible to use an auxiliary electrical source 100, which is designed to create a second electrical field which has lines of force which are incident to the surface to be treated of the manufactured article 5 and is designed to cooperate with the first electrical field in order to cause the migration of the powder particles that flow along the conveyance channel 8 toward the surface to be treated of the manufactured article 5, passing through the passage opening 9 and the partition 4.

In this manner, the powder particles contained in the mixture 3 that passes within the conveyance channel 8 might in practice be under the influence of a total electrical field E, which is the result of the combined action of the first electrical field and of the second electrical field.

Delving further into the details of the apparatus according to the invention, the partition 4 in practice is provided by means of a screen 6, which can have a mesh of variable aperture as a function of the size distribution of the powder particles that one wishes to transfer onto the surface to be treated of the manufactured article 5.

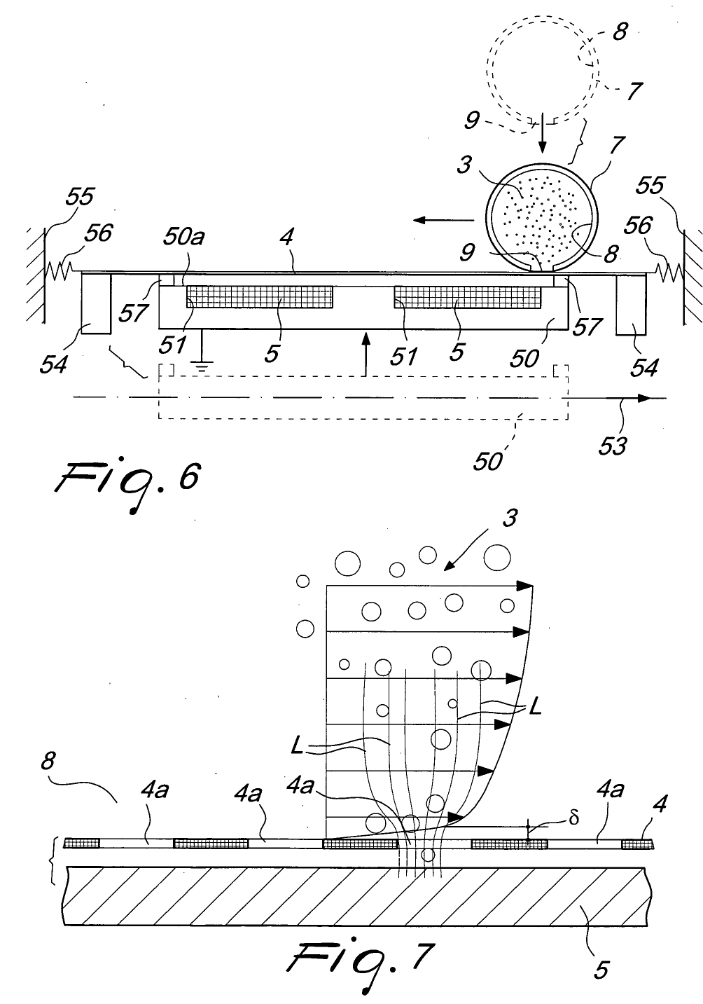

Advantageously, the dielectric material used to provide the partition 4 has a higher dielectric constant than air, so that the lines of force L of the first electrical field and of the second electrical field, if present, tend to pass through the partition 4, passing predominantly within its through ports, as shown schematically in FIG. 7.

In particular, the partition 4 can be made for example of a polyester fabric.

Optionally, the partition 4 may also act as a graphic stencil and in this case it may have blocked regions in order to provide a graphical representation to be transferred onto the surface to be treated of the manufactured article 5.

Such blocked regions are obtained for example by applying a layer of resin at the portions of the screen 6 that must not be crossed by the powder particles, so as to define the graphical configuration that one wishes to reproduce on the manufactured article 5.

Advantageously, the partition 4 is arranged proximate to the duct 7, so as to delimit therewith the conveyance channel 8, closing in practice the passage opening 9.

In this manner, the partition 4 provides a wall of the duct 7, allowing to keep substantially unchanged the fluid dynamics conditions imparted to the mixture 3 in the conveyance channel 8. While powder particles can pass through the partition 4 in order to reach the manufactured article 5, the escape of the gas of the mixture 3, again through the partition 4, is in fact greatly hindered by the clustering of particles of powder on the surface of the partition 4 that is directed toward the inside of the conveyance channel 8.

With the described arrangement of the partition 4 it is further possible to allow the flow of the mixture 3 within the duct 7 to form, on the surface of the partition 4 that is directed toward the inside of the conveyance channel 8, a laminar boundary layer in which the speed of the mixture 3 that passes through the conveyance channel 8 is reduced considerably with respect to its average speed in the duct 7. Accordingly, in the region affected by the laminar boundary layer, the powder particles tend to be more affected by the influence of the first and second electrical fields, which allow their deposition onto the manufactured article 5, with respect to the action of the fluid dynamics forces that are responsible for their entrainment along the duct 7.

It should be noted that within the conveyance channel 8 it is preferable to keep the flow of the mixture 3 in fluid dynamics conditions of low turbulence, in order to ensure reduced load losses along the duct 7 and thus avoid the presence, within the conveyance channel 8, of such hydraulic pressures as to cause the escape of gas from the partition 4. This ensures at the same time good cleaning of the internal walls of the duct 7 and preservation of optimum flow uniformity of the mixture 3 in the conveyance channel 8.

In particular, the mixture 3 can be given such a fluid dynamics condition of motion, within the conveyance channel 8, as to determine, proximate to the surface of the partition 4 that is directed toward the inside of the conveyance channel 8, the presence of a range of speeds which, depending on the physical characteristics of the powder particles and on the deposition conditions to be provided, can be of a practically turbulent type, so as to keep the powder particles suspended within the conveyance channel 8, or of the laminar type, with formation in particular of a laminar boundary layer whose thickness δ is substantially equal to, or at least comparable with, the average particle size of the powder particles.

Conveniently, the flow of the mixture 3, and more precisely of the gas, within the conveyance channel 8, may have a Reynolds number ranging substantially from 10³ to 5×10⁴ and more preferably from 10³ to 10⁴.

By way of example, it has been possible to verify experimentally that with a duct 7 which has a length ranging from 0.8 m to 1 m and an inside diameter ranging from 35 to 40 mm and with an average speed of the stream of mixture 3 within the conveyance channel 8 ranging from 0.2 to 2 m/s, it is possible to obtain optimum fluid dynamics conditions of the mixture 3 within the conveyance channel 8, at least along an intermediate portion of the duct 7 whose length ranges from 0.30 m to 0.50 m, in which the passage opening 9 is provided.

In particular, it has been observed that with these conditions, in the region of the conveyance channel 8 that lies closest to the partition 4 it is possible to witness the formation of a clustering of powder particles which, by being under the predominant influence of the lines of force L of the first electrical field and of the second electrical field, if present, are propelled to pass through the partition 4 and deposit on the surface to be treated of the manufactured article 5, following a trajectory which is imposed by the lines of force L, while at the same time other powder particles that arrive from the remaining part of the conveyance channel 8 replace constantly the particles that have been transferred from the region of the conveyance channel 8 that lies proximate to the partition 4 onto the surface to be treated of the manufactured article 5, so as to keep the clustering of powder particles proximate to the partition 4 uniform.

Experimental tests have allowed to verify that it is particularly advantageous to provide the partition 4 with a controlled surface roughness, which can for example range from Ra 0.1 μm to Ra 100 μm, so as to be able to control the formation and thickness 6 of the laminar boundary layer or even exclude its presence, according to the requirements, all the other general fluid dynamics parameters of the flow of the mixture 3 within the conveyance channel 8 being fixed. In practice, by varying the roughness of the partition 4 it is possible to provide in each instance optimum conditions of deposition of the powder particles as a function of their physical characteristics, such as mass density, particle size distribution, electrical charge and concentration.

Merely by way of example, in order to deposit uniformly onto the surface of the manufactured article 5 predominantly very fine powder particles, i.e., with a diameter substantially ranging from 3 to 25 μm, so as to achieve a high graphical definition of the images, it is convenient for the surface roughness of the partition 4 to range from Ra 0.5 μm to Ra 4.5 μm, with Rz lower than 30 μm. If instead one wishes to deposit predominantly large-size powder particles, i.e., with a diameter ranging for example substantially from 30 to 100 μm, it is preferable to provide a surface roughness of the partition 4 which is much higher, i.e., ranging by way of example from Ra 10 μm to Ra 80 μm, with Rz higher than 30 μm.

Advantageously, the partition 4 can have a controlled roughness on both sides, i.e., the one directed toward the inside of the duct 7 and the opposite one directed toward the manufactured article 5 to be decorated.

Conveniently, the controlled roughness of the partition 4 can be achieved by embossing the partition 4 itself or by applying a layer of resin with solid microgranules embedded therein, designed to protrude partially from the layer of resin after its curing.

Optionally, the partition 4 and the internal walls of the duct 7 can have a greater roughness in localized regions, so as to be able to control locally the turbulence of the flow of the mixture 3, and the formation, the dimensions or the very presence of a laminar boundary layer.

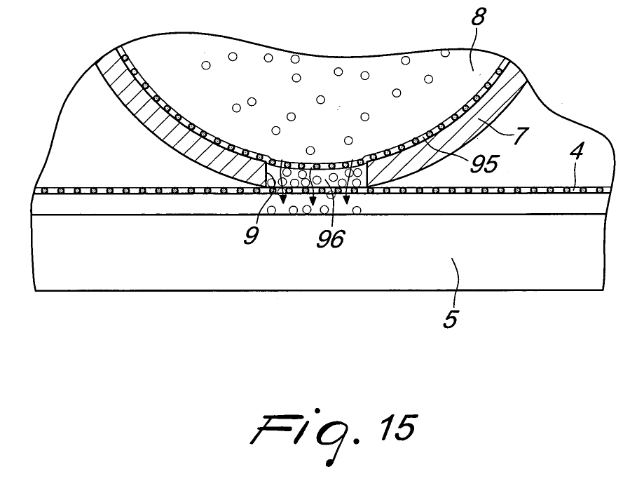

Conveniently, as shown in FIG. 15, it is possible to apply to the internal walls of the duct 7 an auxiliary partition 95, which closes the passage opening 9 of the duct 7 on its side directed toward the conveyance channel 8, so as to delimit with the partition 4 a chamber 96 in which the powder particles can accumulate without being influenced by the fluid dynamics forces that act within the conveyance channel 8 of the duct 7.

As shown in the constructive variation of FIG. 3, there is nothing to prevent the duct 7 from being open also on its side which is diametrically opposite with respect to the passage opening 9, it being understood that in this case there may be a loss of efficiency in the action of the first and second electrical fields.

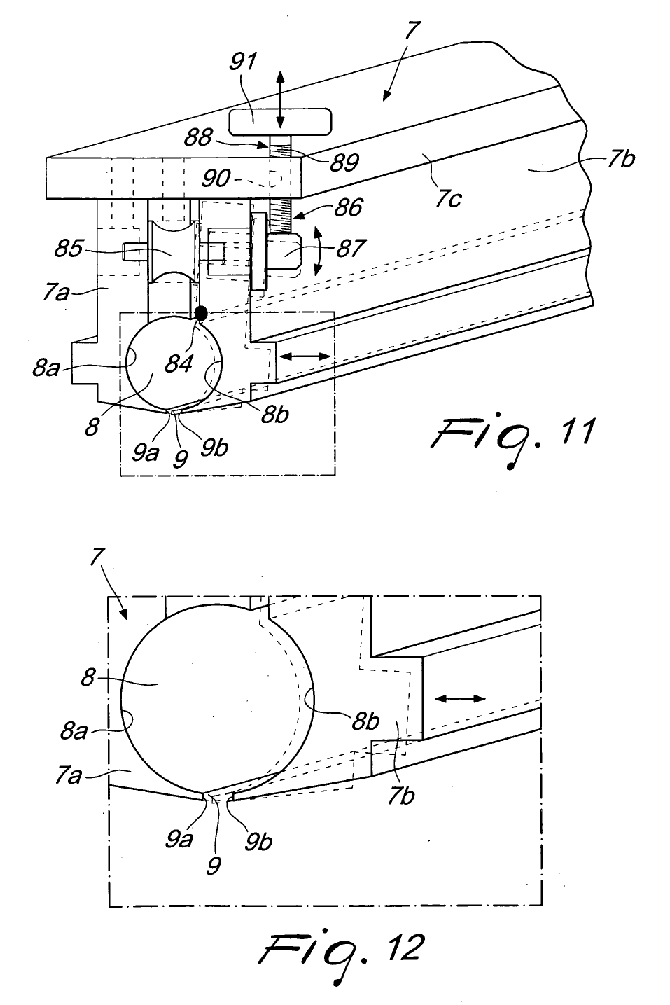

As shown in the example of FIGS. 11 and 12, the duct 7 can be provided advantageously with means for adjusting the breadth of the passage opening 9, which conveniently allow to vary the dimensions of the passage opening 9 so that it can have a progressively greater transverse breadth, proceeding in the advancement direction of the flow of the mixture 3 in the conveyance channel 8. It has in fact been observed that by adjusting in this manner the dimensions of the passage opening 9, a greater uniformity of transfer of the powder particles onto the surface to be decorated of the manufactured article 5 can be achieved.

Advantageously, such means for adjusting the breadth of the passage opening 9 can be obtained by providing the duct 7 by means of two elongated bodies, respectively a first body 7a and a second body 7b which face each other and are connected one another so as to rotate with respect to each other about an axis which is substantially parallel to their longitudinal extension. The first body and the second body 7a and 7b have, on their mutually facing faces, two recesses 8a and 8b which define respective portions of the conveyance channel 8 and delimit the passage opening 9 with their longitudinal edges 9a, 9b which lie proximate to the two recesses 8a and 8b. Conveniently, in order to ensure the seal, a gasket 84 acts between the bodies 7a, 7b and is arranged proximate to the recesses 8a, 8b on the opposite side with respect to the passage opening 9. The first and second bodies 7a and 7b are further connected to each other at one of their regions located on the opposite side with respect to their longitudinal edges 9a, 9b by means of an elastic joint, which is obtained by interposing a connecting body 85 made of elastically yielding material, so as to allow to turn one of the two bodies, which in the illustrated example is constituted by the second body 7b, with respect to the first body 7a about a rotation axis which is substantially parallel to the longitudinal extension of the first and second bodies 7a, 7b in the direction that produces the mutual approach of their longitudinal edges 9a and 9b or optionally in the opposite direction, so as to be able to reduce or increase the transverse breadth of the passage opening 9. As can be seen in FIG. 11, pusher means 86 act on the second body and allow to turn adjustably the second body 7b with respect to the first body 7a in order to vary the dimensions of the passage opening 9. Conveniently, said pusher means 86 comprise a lug 87, which protrudes from the face of the second body 7b that is directed away from the first body 7a and lies substantially at right angles to the rotation axis of the second body 7b with respect to the first body 7a. The lug 87 is advantageously arranged proximate to the longitudinal end of the second body 7b that corresponds to the inlet end of the duct 7. An adjustment element 88 is designed to act on the lateral surface of the lug 87 and is adapted to apply to the lug 87 a force directed substantially at right angles to the axis of the lug 87 and substantially at right angles to the longitudinal axis of the second body 7b and therefore to its axis of rotation with respect to the first body 7a. Conveniently, the adjustment element 88 is constituted by a threaded pin 89 which rests, with one of its ends, against the lateral surface of the lug 87 and engages in a seat 90 which is defined through a supporting plate 7c, which is rigidly connected to the first body 7a. Conveniently, the threaded pin 89 is provided, at its other end, with an actuation head 91. With this structure, in practice, by acting on its actuation head 91 it is possible to produce the translational motion of the threaded pin 89 along the seat 90, so as to apply to the lateral surface of the lug 87 a thrust which is capable of turning the second body 7b, with respect to the first body 7a, in contrast with the elastic reaction of the connecting body 85, with consequent movement of the longitudinal edge 9b of the second body 7b toward the longitudinal edge 9a of the first body 7a only in their end region that corresponds to the inlet end of the duct 7, so as to vary the transverse dimension of the passage opening 9 so that it increases progressively as one proceeds toward the opposite end of the duct 7.

Conveniently, the partition 4 can be movable with respect to the duct 7 along a direction which is substantially transverse or parallel with respect to the extension of the conveyance channel 8, so as to always have a clean portion at the passage opening 9 of the duct 7.

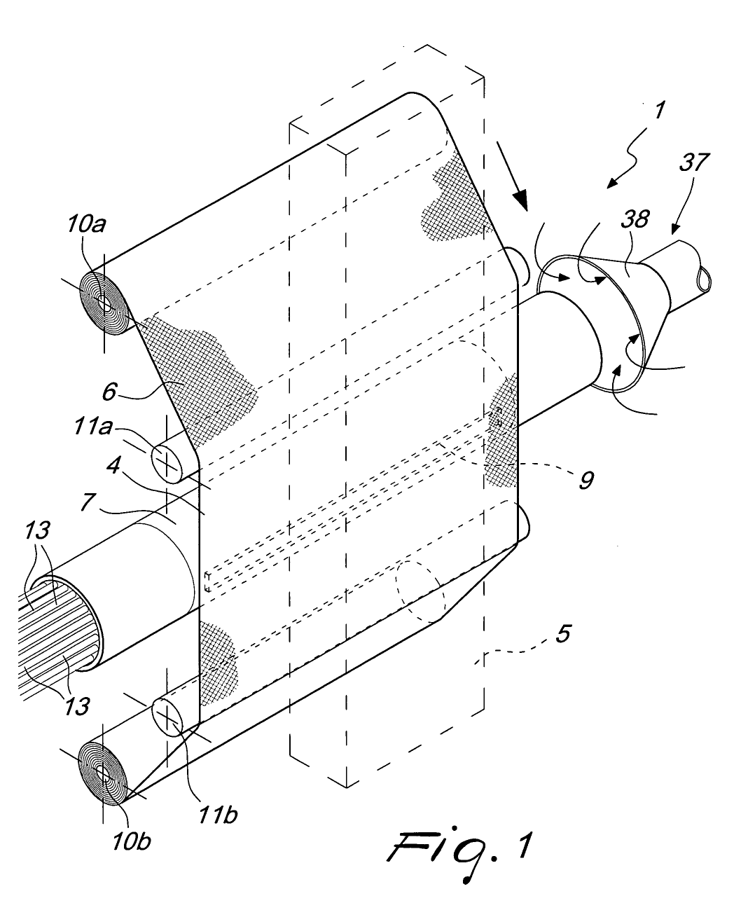

More particularly, with reference to the embodiment shown in FIGS. 1 to 3, the screen 6 can be constituted by a belt which extends between a pair of movement rollers 10a, 10b and is conveniently engaged by a pair of guiding cylinders 11a and 11b, between which the duct 7 is interposed so that the screen 6 can be perfectly flat at the passage opening 9 of the duct 7.

Advantageously, the manufactured article 5 also can be movable, with respect to the duct 7, along a direction which is substantially transverse or parallel with respect to the longitudinal axis of the duct 7, so that in its movement the manufactured article 5 can direct, in each instance, toward the passage opening 9 a different portion of its surface to be treated.

It should be noted that the manufactured article 5 and the partition 4 may also be both movable, with respect to the duct 7, along a direction which is substantially transverse or parallel to the longitudinal axis of the duct 7.

Optionally, the manufactured article 5 and the partition 4 can move synchronously with respect to each other and in the same advancement direction.

In this manner, as the manufactured article 5 advances together with the partition 4, it can be decorated according to the image optionally provided on the partition 4 by projection of the powder particles that transit along the conveyance channel 8 onto the surface to be treated, said projection being obtained by way of the action of the first electrical field and of the second electrical field, if present.

As an alternative, the manufactured article 5 and the partition 4 may also have a relative speed of one with respect to the other, so as to be able to obtain particular shading effects in the images printed by means of the powder particles on the surface to be treated of the manufactured article 5.

It should also be added that of course there is nothing to prevent the duct 7 from being actuated to move with respect to the partition 4 and to the manufactured article 5, during the application of the powder particles to the surface to be treated of the manufactured article 5.

For example, this is the case of a possible embodiment of the apparatus according to the invention shown in FIG. 6, which can be used particularly but not necessarily in lines for the production of ceramic articles, such as tiles or the like.

In this embodiment, there is a slider 50, of a per se known type, on one face 50a of which there are cavities 51 in which ceramic powders are pressed which form the manufactured articles 5 to be treated.

In particular, the slider 50 can perform a translational motion along an advancement line 53 which passes through several stations for processing the manufactured articles 5.

In its motion along the advancement line 53, the slider 50 is moved to a position in which it faces, with its face 50a, the partition 4, which in this case is provided for example by a screen-printing panel of a per se known type, which is associated perimetrically with a frame 54 which conveniently is connected to a fixed structure 55 by interposing means 56 of any known type for adjusting the position of the screen-printing panel.

Once the slider 50 is in a position which faces the partition 4, its movement along the advancement line 53 is stopped.

At this point, the slider 50 is moved toward the partition 4 until it rests against the partition 4 by means of protrusions 57 provided on its face 50a, in order to keep the surface to be treated of the manufactured articles 5 spaced from the partition 4.

On the opposite side of the slider 50 with respect to the partition 4 there is the duct 7, which, with the slider 50 rested against the partition 4, is moved toward the partition 4 until it rests, with the edges of the passage opening 9, against an end region of the partition 4.

Once the duct 7 also rests on the partition 4, the dispensing device 2 is activated so that the conveyance channel 8 of the duct 7 is fed with the mixture 3 and simultaneously the duct 7 is made to slide on the surface of the partition 4 toward the opposite end region of the partition 4.

Optionally, the slider 50 and accordingly the manufactured articles 5 can be connected to the ground so as to bring them to a reference electrical potential.

During the sliding motion of the duct 7 on the surface of the partition 4, there is a controlled transfer of powder particles from the duct 7 onto the surface to be treated of the manufactured articles 5, through the partition 4, due to the action of the first electrical field established due to the difference in electrical potential that is present between the set of charges carried by the powder particles and by the gas of the mixture 3 that passes through the conveyance channel 8 and the manufactured articles 5.

Once the decoration of the manufactured articles 5 has ended, the duct 7 is returned to its initial position, while the slider 50 is moved away from the partition 4 and again brought to the advancement line 53, so as to be able to pass to another station for processing the manufactured articles 5.

At this point, before the arrival of another slider 50 from the advancement line 53, means for cleaning the partition 4 can intervene conveniently; such means are not shown and are constituted for example by a dispensing outlet which is adapted to emit a blade of air through the partition 4, so as to separate any powder particles that have remained on the surface of the partition 4, and is made to advance parallel to the partition 4, so as to affect with the blade of air the entire surface of the partition 4.

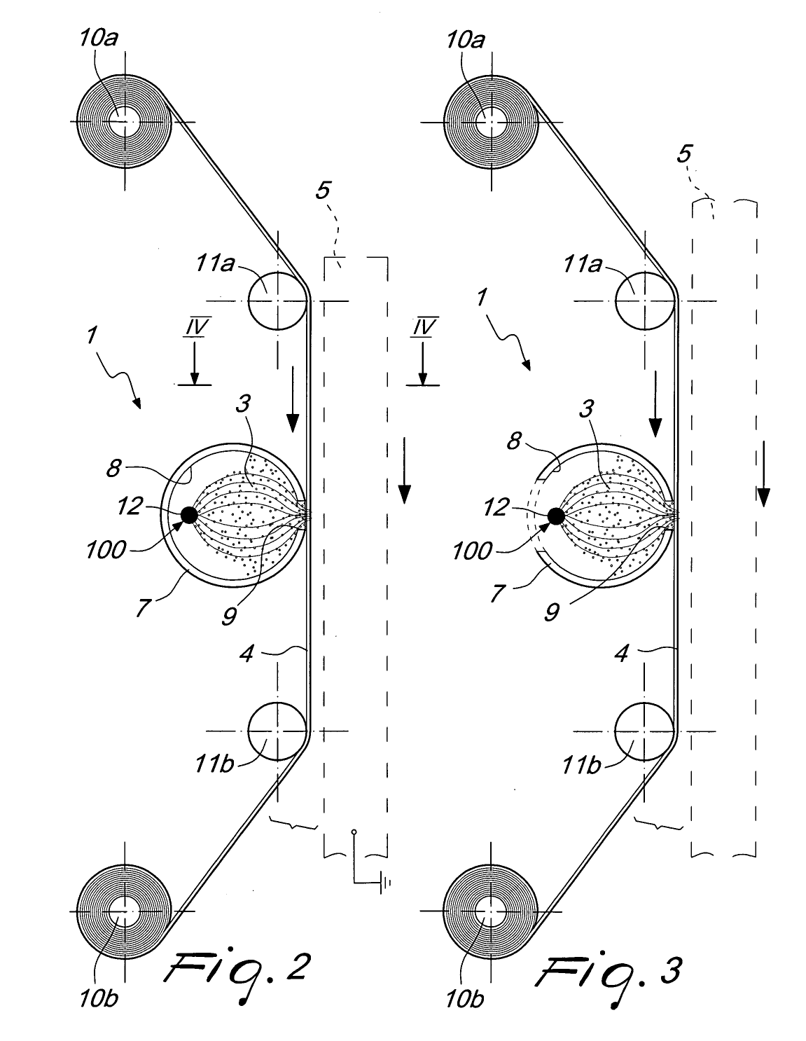

Advantageously, the above cited auxiliary electrical source 100 is constituted by electricity generation means, which are arranged along the conveyance channel 8 and are adapted to generate the second electrical field so that at least part of its lines of force lie, with at least one of their components, substantially transversely to the longitudinal extension of the conveyance channel 8 and conveniently close on the surface to be treated of the manufactured article 5, passing through the partition 4, as can be seen in FIGS. 2 and 3.

Preferably, such electricity generation means are constituted by at least one filament 12, which extends along the conveyance channel 8 and is arranged on the opposite side with respect to the passage opening 9, so as to face the partition 4 and be spaced from it. In particular, the filament 12 is designed to be arranged at a predefined electrical potential, for example by a voltage source which is connected thereto or by electrical induction, so that the second electrical field can be generated between the filament 12 and the manufactured article 5.

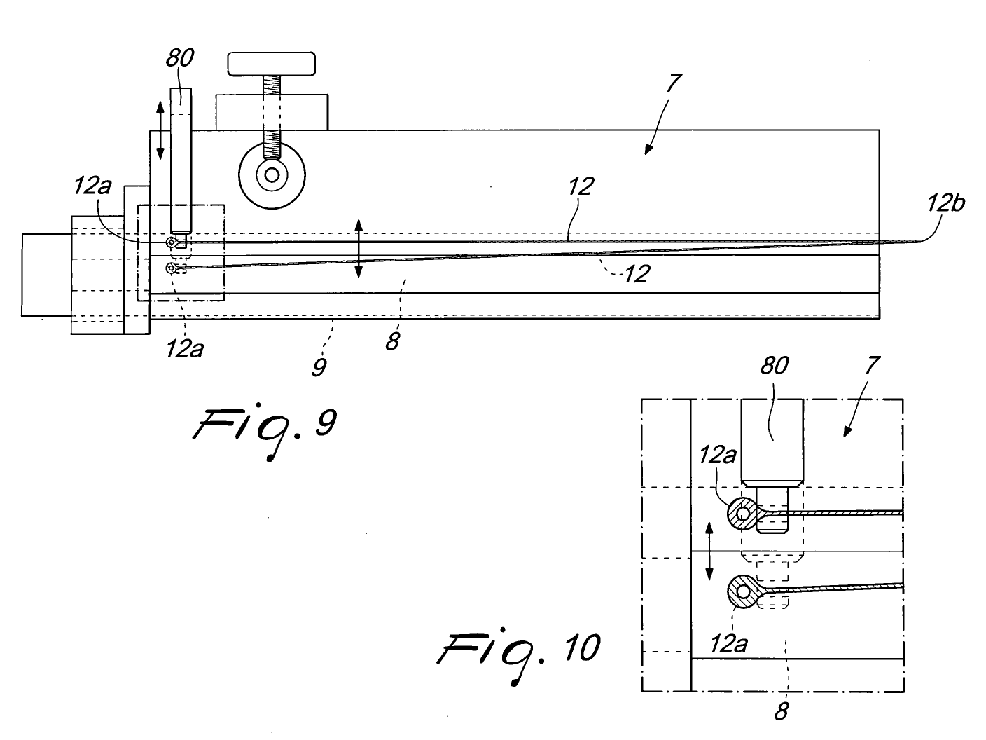

As shown in FIGS. 9 and 10, it is conveniently possible to provide also means for varying the distance between the filament 12 and the passage opening 9, which advantageously comprise a slide element 80, which is connected rotatably to the filament 12, at its end 12a which lies proximate to the inlet of the duct 7, and can perform an adjustable translational motion, with respect to the duct 7, toward or away from the passage opening 9. Conveniently, at its opposite end 12b the filament 12 is connected to the duct 7. In this manner, by acting on the slide element 80, it is possible to arrange the filament 12 so that its distance from the passage opening 9 increases progressively in the advancement direction of the flow of the mixture 3 within the conveyance channel 8 of the duct 7, as shown schematically in FIG. 9.

It should be noted that the internal walls of the duct 7 that delimit the conveyance channel 8 are conveniently made of an electrically insulating material, such as for example of a dielectric material with a considerably higher dielectric constant than air, so as to not affect the first electrical field and the second electrical field, if provided.

In this manner it is possible to obtain in practice that the first electrical field and the second electrical field generated by the filament 12 have lines of force which affect transversely the passage sections of the duct 7, deviating proximate to the passage opening 9 to concentrate at the partition 4, where the electrostatic forces have such an intensity as to convey, through the partition 4 and until they reach the surface to be treated of the manufactured article 5, the powder particles that transit along the conveyance channel 8 and are forced to concentrate in the region of the conveyance channel 8 that lies proximate to the partition 4 due to the viscous forces that prevail within the laminar boundary layer that forms in said region.

It should be noted that according to other possible exemplary embodiments, the filament 12 optionally can be replaced by a plurality of filaments which are mutually parallel or interwoven, or by a net of conducting material which is arranged so as to face the passage opening 9 and is supplied with electric power so as to create the second electrical field through the passage opening 9 and the partition 4.

As shown, the dispensing device 2 is connected to the duct 7 by means of at least one tubular connecting element 13, preferably of the flexible type.

In order to achieve the most uniform possible distribution of the powder particles in the conveyance channel 8, advantageously the duct 7 is connected to the dispensing device 2 by means of a plurality of tubular connecting elements 13, which are distributed uniformly at an inlet section of the conveyance channel 8 which in practice corresponds to the inlet of the duct 7, engaging partly in the duct 7, so that each one dispenses its own jet of mixture 3 into the conveyance channel 8.

Advantageously, the dispensing device 2 is provided with electrical charging means designed to charge electrically the mixture 3 by triboelectric effect or by corona effect.

More particularly, the dispensing device 2 is conveniently connected to a line 16 for feeding the mixture 3. The above cited electric charging means preferably comprise a source 20 of an electrostatic charging field, the lines of force 20a of which are directed so as to strike the flow of the mixture 3 that arrives from the feed line.

Advantageously, the source 20 is formed by at least one control electrode 22, which is arranged substantially coaxially to the feed line 16, and by at least one reference electrode 24, which is arranged laterally with respect to the axis of the feed line 16.

In particular, the control electrode 22 can be charged electrically, by means for example of a voltage source 23, to generate the electrostatic field for charging the mixture 3 between the control electrode 22 and the reference electrode 24.

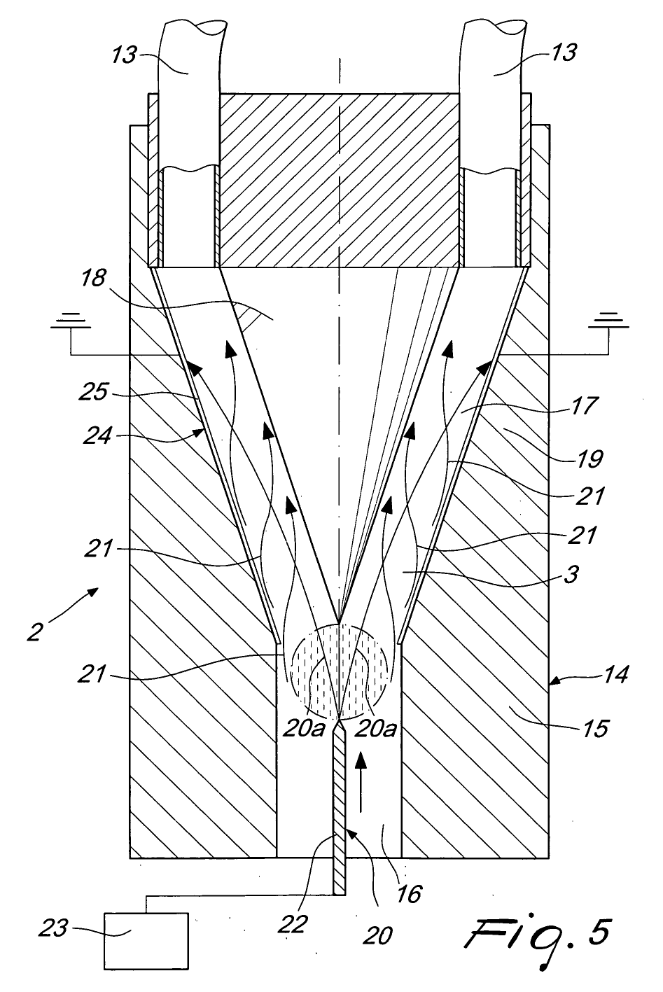

As shown in particular in FIG. 5, the dispensing device 2 can be structured for example so as to comprise a distribution head 14, which has a body 15 inside which there is a conical channel 17 which in input is connected to the feed line 16 and leads in output into the tubular connecting elements 13, so as to distribute the flow of the mixture 3 fed by the feed line 16 in the several tubular connecting elements 13, which are distributed uniformly along an annular portion and are connected to the body 15 of the distribution head 14.

For example, the conical channel 17 is delimited between a conical diffuser 18, arranged coaxially to the feed line 16 of the mixture 3, and a portion of frustum-shaped outer wall 19 which is formed on the body 15 of the distribution head 14.

With reference again to the embodiment of FIG. 5, the control electrode 22 is accommodated coaxially with respect to the feed line 16 in a position which is proximate to the conical channel 17, while the reference electrode 24 is constituted by at least one plate 25 made of electrically conducting material, which is arranged within the conical channel 17 and can be connected to the ground, so that as a consequence of the activation of the control electrode 22 it is possible to establish the lines of force 20a of the electrostatic charging field of the mixture 3 between the control electrode 22 and the plate 25.

Preferably, the plate 25 is provided by means of a coating of electrically conducting material which is arranged on the internal surface of the conical channel 17 and in particular of the frustum-shaped outer wall portion 19.

It should be noted that with this structure of the source 20 it is possible to obtain not only an optimum electrical charging of the powder particles sent to the tubular connecting elements 13 and therefore to the conveyance channel 8 but also the collection from the mixture 3 of any unwanted excess ions that might interfere with the correct deposition of the powder particles on the surface to be treated and can form between the molecules of the gas in their passage proximate to the control electrode 22 once such electrode is charged electrically.

Moreover, it should be noted that in order to avoid influencing negatively the action of the electrostatic field created by the source 20, the body 15 of the distribution head 14 is conveniently made of insulating material.

Moreover, it is important to note that the ratio between the dimension of the passage section of the feed line 16 and the sum of the dimensions of the passage sections of the several tubular elements 13 is preferably 1 to 3, and likewise it is preferable for the ratio between the sum of the dimensions of the passage sections of the several tubular elements 13 and the dimension of the passage section of the conveyance channel 8 to be 1 to 3.

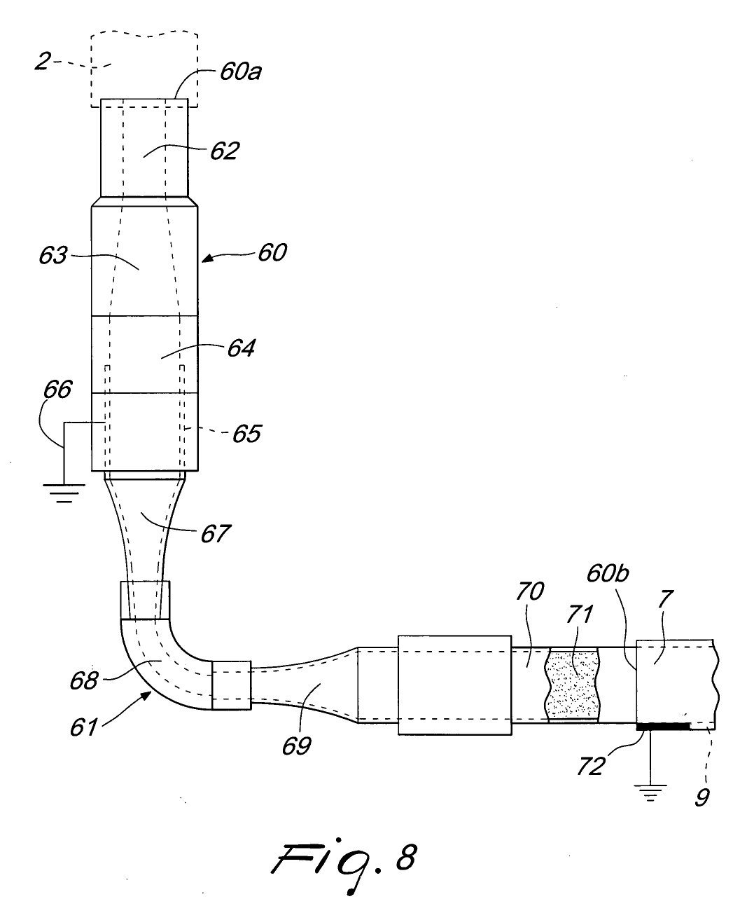

According to a different embodiment, shown in FIG. 8, the several tubular elements 13 can be replaced by a single pipe 60, which has, at any elbows 61, a choke in order to ensure the uniformity of the mixture 3.

More particularly, the pipe 60 has an inlet end 60a, which can be connected to the dispensing device 2, and an outlet end 60b, which is designed to be connected to the inlet of the duct 7. It should be noted that in this case the dispensing device 2 can be constituted also by a conventional spray gun for electrostatic powders of any known type.

Examining now in detail the pipe 60, starting from its inlet end 60a and proceeding toward its outlet end 60b, there is, for example, a first cylindrical portion 62, which is connected to the dispensing device 2 and reaches a diverging portion 63, which allows expansion of the stream of the mixture 3. The diverging portion 63 in turn leads into a second cylindrical portion 64, which is lined internally by a metallic layer 65 which is connected to a grounding cable 66 and is designed to discharge to the ground any excess electrostatic charge that might be present in the mixture 3.

In the presence of bends 61 along the pipe 60, advantageously there can be a converging portion 67 with curved walls, which allows to increase the speed of the mixture 3, to avoid stream separations in the bend 61, an actual bend portion 68, preferably with a polygonal and more preferably rectangular cross-section, followed by a portion with a progressive increase of the cross-section 69, also with curved walls, to reduce load losses.

Advantageously, proximate to its outlet end 60b, the pipe 60 has a cylindrical end portion 70 which has a rough internal surface 71, obtained for example by applying a layer of sand and adhesive material, which allows to maintain a certain turbulence in the flow of the mixture 3 in order to prevent the powder particles from depositing on the internal walls of the end portion 70 before entering the duct 7.

Advantageously, on the duct 7 or optionally on the pipe 60 and in any case upstream of the useful region of the duct 7 affected by the passage opening 9, a strip 72 of conducting material such as aluminum is applied and is grounded and positioned on the same side of the duct 7 in which the passage opening 9 is provided. The strip 72 allows to attract toward the region of the passage opening 9 the powder particles before they reach the actual useful region of the duct 7. The strip 72 can be arranged equally on the internal wall of the duct 7, so as to have an amplified effect, or more conveniently on the outer surface of the duct 7. In any case, on the internal wall of the duct 7, at the region where the strip 72 is provided, there is an increase in roughness by means of the application with adhesive of sand grains which have a particle size of approximately 300 μm.

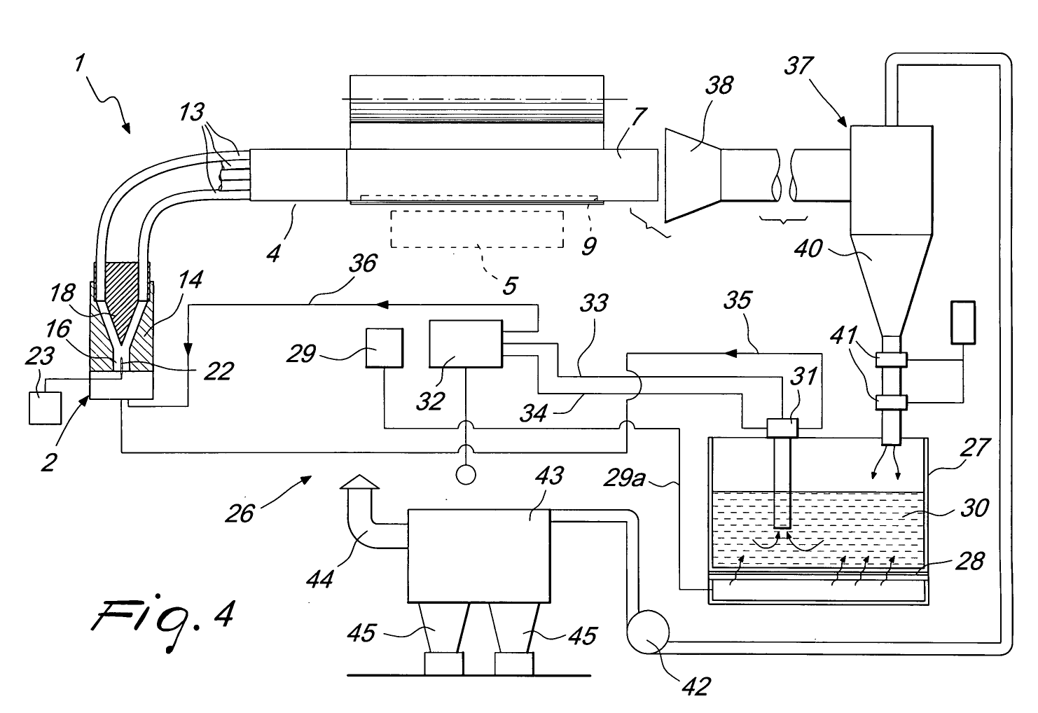

As shown in the exemplifying diagram of FIG. 4, the feed line 16 of the dispensing device 2 can be connected to a system 26 for feeding the mixture 3, which is designed to form a uniform suspension of powder particles in air.

In particular, the feeding system 26 has a collection tank 27 inside which there is a porous partition 28, which is designed to be crossed from the bottom upwardly by a stream of pressurized air sent by a first air injection assembly 29 by means of a feed pipe 29a.

The porous partition 28 delimits in a downward region, within the collection tank 27, a mixing chamber, in which the powder particles are introduced in order to be mixed with the air injected through the porous partition 28, thus generating a fluid bed 30.

The powder particles mixed with the air are drawn from the collection tank 27 by means of a pump which is constituted for example by a Venturi tube 31, which is fed by a second air injection assembly 32 designed to dispense, by means of a first control pipe 33, a stream of primary air, which allows to create in the Venturi tube 31 the partial vacuum required to aspirate the mixture 3 from the fluid bed 30 and, by means of a second control pipe 34, a secondary air stream in order to introduce in the Venturi tube 31 an amount of air which is sufficient to convey the mixture 3 to the feed line 16 by means of a delivery duct 35.

Advantageously, upstream of the distribution head 14 an additional air stream is further fed into the feed line and is fed for example by the second air injection assembly 32 through a third control duct 36 in order to dilute the mixture 3 and send it to the distribution head 14 with a controlled mass flow-rate.

Conveniently, as can be seen in the example shown in FIG. 1 and in FIG. 4, the duct 7 can discharge in output at atmospheric pressure, in order to limit the presence of unwanted overpressures inside the conveyance channel 8.

In order to collect any particles of powder that have not been involved in the coating process, advantageously there is, downstream of the outlet of the duct 7, a device 37 for recovering powder particles, which by means of a conical suction collector 38 which faces the outlet end of the duct 7 allows to draw air also from the outside environment in order to avoid scattering into the atmosphere the powder particles discharged from the duct 7.

Conveniently, the conical suction collector 38, by means of an appropriately provided connecting tube 39, conveys the recovered powder particles into a cyclone unit 40, which separates the powder particles from the air and accumulates them in its lower conical portion, from which they can be drawn, for example by means of at least two peristaltic valves 41, in order to be introduced in the collection tank 27 of the supply system 26 of the distribution head 14.

Advantageously, the air purified by the cyclone unit 40 is aspirated by a fan 42 and sent to a filter 43 before being expelled into the atmosphere by means of a stack 44. The powder particles retained by the filter 43 are collected in appropriately provided recovery containers 45.

It is further possible to use powder particles of different sizes in the mixture 3. In this case, the finer particles are involved in deposition on the manufactured article 5, while the larger particles are designed to ensure correct cleaning of the internal walls of the duct 7 by means of their sliding along the duct 7.

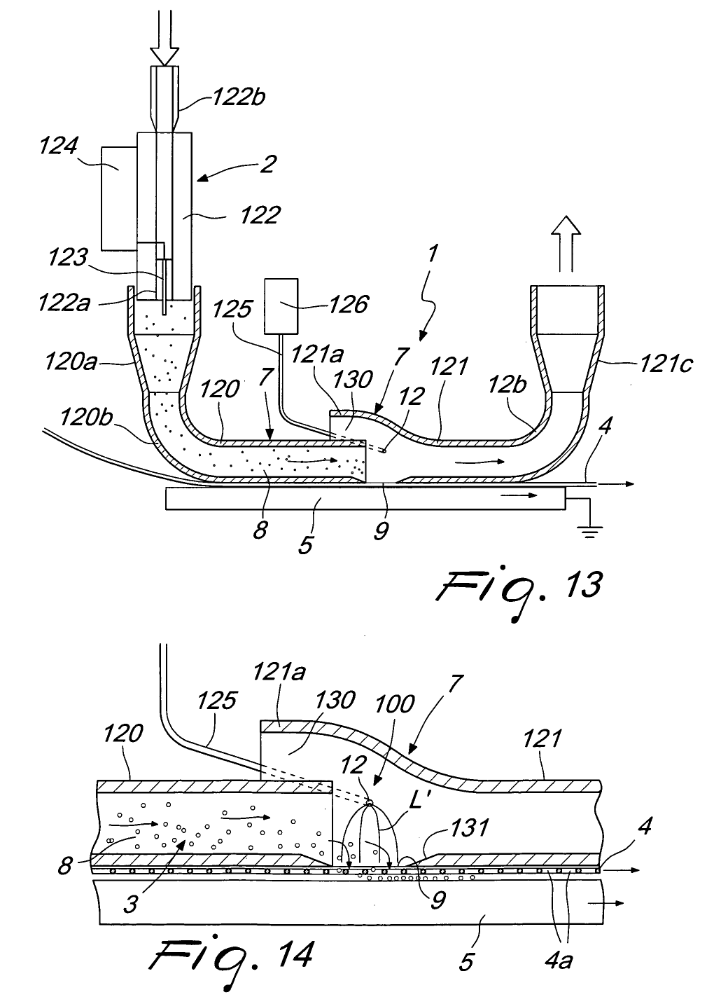

FIGS. 13 and 14 illustrate a different constructive solution of the apparatus according to the invention, in which the duct 7 is provided by means of a first delivery portion 120 and a second intake portion 121 which are mutually adjacent, at one end, so that the passage opening 9 is formed at their connecting region.

Describing now in detail this constructive solution, the delivery portion 120 is connected, at its opposite end with respect to the end connected to the intake portion 121, to the device 2 for dispensing the mixture 3, which in this case advantageously can be constituted by a normal spray gun 122. In particular, the spray gun 122 conveniently can be inserted hermetically, with its outlet 122a, in the delivery portion 120 and is connected, with its inlet 122b, to a source of the mixture 3, which is constituted for example by the feeding system 26 described above. Proximate to the outlet 122a of the spray gun 122 there is axially a charging electrode 123, which is fed by a high-voltage source 124 in order to charge electrically the powder particles dispensed by the spray gun 122 in the delivery portion 120.

Conveniently, downstream of the spray gun 122, the delivery portion 120 has a reduction in cross-section 120a, so as to increase the speed of the flow inside it; moreover, it progressively approaches the partition 4 and the manufactured article 5, performing a bend 120b, so that its axis becomes substantially parallel to the partition 4 and to the surface to be decorated of the manufactured article 5, so as to form the initial part of the actual duct 7.

Advantageously, the intake portion 121 is connected to the delivery portion 120 by means of a cup-shaped portion 121a which accommodates with play the outlet end portion of the delivery portion 120 so as to define a region 130 for connection to the outside environment. Conveniently, the cup-shaped portion 121a of the intake portion 121 has, on its side directed toward the partition 4 and the manufactured article 5, a hollow 131, so as to define, in the region connecting the delivery portion 120 and the intake portion 121, the passage opening 9, which in this case lies substantially transversely to the longitudinal axis of the duct 7.

Downstream of the cup-shaped portion 121 a, the intake portion 121 lies, with one of its portions, parallel to the partition 4 and to the surface to be decorated of the manufactured article 5, so as to form the end portion of the duct 7, and then moves progressively away from the partition 4 and from the manufactured article 5, forming a bend 121b and connecting, after an increase in its cross-section 121c, to a suction unit, which is not shown.

In this case, the manufactured article 5 and the partition 4 are conveniently moved parallel to the duct 7. It should be noted that at the passage opening 9 the edges of the delivery portion 120 and of the intake portion 121 have a sharp edge, which allows to collect the powder particles that have remained on the surface of the partition 4 as it advances.

Advantageously, in this constructive solution also, inside the duct 7 and particularly at the connecting region between the delivery portion 120 and the intake portion 121, there is an auxiliary electrical source 100, which is constituted, as in the preceding examples, by a filament 12, which is arranged so as to face the passage opening 9 and be spaced from it. As shown schematically in FIG. 14, the filament 12 is powered, by means of a connecting cable 125, by a high-voltage electric source 126, in order to generate an electrical field which has lines of force, designated by the reference sign L′, which pass through the passage opening 9 and the partition 4 and are incident to the surface to be decorated of the manufactured article 5, which is conveniently connected to the ground, in a per se known manner, so as to facilitate the transfer of the powder particles onto its surface to be decorated.

From what has been described above it can be understood easily that the apparatus according to the invention is capable of performing, in all of its embodiments, a more controlled deposition of the powder particles on the surfaces to be coated with respect to the background art, since it allows to keep much more easily under control the fluid dynamics and electrostatic conditions that are fundamental to obtain an optimum deposition of the powder particles on the parts to be decorated.

The fact should also be stressed that the apparatus according to the invention allows to provide extremely uniform and controlled conditions for the deposition of the powder particles, regardless of their size, on the surface of the part to be decorated.

All the characteristics of the invention indicated above as advantageous, convenient or the like may also be omitted or be replaced with equivalents.

The individual characteristics described with reference to general teachings or to particular embodiments may all be present in other embodiments or may replace characteristics in such embodiments.

The invention thus conceived is susceptible of numerous modifications and variations, all of which are within the scope of the inventive concept.

In practice, the materials used, so long as they are compatible with the specific use, as well as the shapes and dimensions, may be any according to requirements.

All the details may further be replaced with other technically equivalent elements.

The disclosures in European Patent Application No. 08425168.5 from which this application claims priority are incorporated herein by reference.

What is claimed is:

1. An apparatus for applying electrostatic powders on manufactured articles in general, comprising: at least one dispensing device which is adapted to dispense a mixture formed by a gas and by solid particles of powder, at least said solid particles of powder in said mixture having an electrostatic charge; at least one duct, connected to said at least one dispensing device and arranged proximate to a surface to be treated of a manufactured article, said dispensing device defining a channel for conveying said mixture, said at least one duct having laterally, along its longitudinal extension, at least one passage opening which is directed toward said surface to be treated; and a partition arranged with at least one portion thereof substantially at said at least one passage opening, said partition being permeable to said powder particles, said at least one passage opening and said partition being adapted to be crossed by the lines of force of at least one first electrical field which is adapted to cause transfer of said powder particles that transit along said conveyance channel on said surface to be treated through said at least one passage opening and said partition.

2. The apparatus of claim 1, wherein said at least one first electrical field is generated by a difference in electrical potential between a mass of said mixture that passes through said conveyance channel and the manufactured article.

3. The apparatus of claim 2, wherein said manufactured article is connected to a reference potential for said at least one first electrical field.

4. The apparatus of claim 2, comprising an auxiliary electrical source of a second electrical field which has lines of force which are incident to the surface to be treated and is adapted to cooperate with said at least one first electrical field in order to cause migration of the powder particles toward the surface to be treated through said partition.

5. The apparatus of claim 1, wherein walls of said at least one duct that delimit said conveyance channel are made of electrically insulating material.

6. The apparatus of claim 1, wherein said partition has a plurality of through ports which have a controlled size, in order to allow passage of powder particles which have predetermined dimensions.

7. The apparatus of claim 6, wherein said partition is constituted by a screen.

8. The apparatus of claim 7, wherein said partition is made of dielectric material.

9. The apparatus of claim 6, wherein said partition has a controlled surface roughness.

10. The apparatus of claim 7, wherein said partition is arranged proximately to said duct, so as to delimit with the duct said conveyance channel.

11. The apparatus of claim 10, wherein said partition is movable with respect to said duct along a direction which is substantially parallel or transverse to an axis of said duct.

12. The apparatus of claim 11, wherein said manufactured article is arranged movable with respect to said duct along a direction which is substantially parallel or transverse with respect to the axis of said duct.

13. The apparatus of claim 4, wherein said auxiliary electrical source comprises electricity generation means which are arranged along said conveyance channel and are adapted to generate said second electrical field with at least part of its lines of force which extend through said conveyance channel substantially transversely with respect to its longitudinal axis.

14. The apparatus of claim 13, wherein said electricity generation means comprise at least one filament which extends along said channel and is adapted to be placed at a predefined electrical potential, said filament facing said partition and being spaced from the partition.

15. The apparatus of claim 14, comprising means for varying a distance between said filament and said at least one passage opening.

16. The apparatus of claim 1, comprising means for adjusting a breadth of said at least one passage opening.

17. The apparatus of claim 16, characterized in that said duct is formed by a delivery portion and an intake portion, which are mutually coupled and lie, along at least one portion thereof, substantially parallel to a surface to be decorated of the manufactured article, said at least one passage opening being defined in a connecting region between said delivery portion and said intake portion.

18. The apparatus of claim 1, comprising at least one tubular connecting element, said at least one dispensing device being connected to said duct by way of said least one tubular connecting element.

19. The apparatus of claim 1, comprising a plurality of tubular connecting elements which are distributed uniformly at an inlet section of said conveyance channel, said duct being connected to said at least one dispensing device by way of said plurality of tubular connecting elements.

20. The apparatus of claim 1, wherein said at least one dispensing device comprises electrical charging means which are adapted to charge the mixture electrically by triboelectric effect or by corona effect.

21. The apparatus of claim 20, comprising a feed line for feeding said mixture, said at least one dispensing device being connected to said feed line, said electrical charging means comprising a source of an electrostatic charging field which has lines of force adapted to strike a flow of said mixture that arrives from said feed line.

22. The apparatus of claim 21, wherein said source comprises at least one control electrode, which is arranged substantially coaxially to said feed line, and at least one reference electrode, which is arranged laterally with respect to an axis of said feed line, said at least one control electrode being electrically chargeable in order to generate, between said at least one control electrode and said at least one reference electrode, the electrostatic charging field.

23. The apparatus of claim 22, wherein said at least one dispensing device comprises a distribution head, which has a body which defines a conical channel connected in input to said feed line and leading into said tubular connecting elements.

24. The apparatus of claim 23, wherein said control electrode is accommodated coaxially with respect to said feed line in a position which is proximate to said conical channel, said at least one reference electrode comprising at least one plate made of electrically conducting material, which is arranged within said conical channel and is connectable to ground in order to establish, as a consequence of an activation of said control electrode, said electrostatic charging field between said at least one control electrode and said at least one plate.

25. The apparatus of claim 24, wherein said at least one plate comprises a lining made of electrically conducting material of the internal surface of said conical channel.

26. The apparatus of claim 23, wherein the body of said distribution head is made of an electrically insulating material.

27. The apparatus of claim 9, wherein said powder particles are made of a dielectric material.

28. The apparatus of claim 27, wherein said powder particles have a size distribution ranging from 2 μm to 300 μm, and more preferably from 10 μm to 80 μm.

29. The apparatus of claim 28, wherein said mixture has a concentration by volume of said powder particles which substantially ranges from 0.10 g/dm³ to 20 g/dm³.

30. The apparatus of claim 28, wherein a flow of said mixture within said conveyance channel has fluid dynamics conditions adapted to create on a surface of said partition, that is directed toward an inside region of said conveyance channel, a laminar boundary layer whose thickness is dimensionally substantially comparable to an average particle size of said powder particles.

31. The apparatus of claim 30, wherein the flow of said mixture within said conveyance channel has a Reynolds number ranging substantially from 10³ to 5×10⁴.

32. A method for applying electrostatic powders to manufactured articles in general by way of an apparatus as set forth in claim 1, the method consisting in: feeding an electrically charged mixture formed by a gas and by powder particles to a duct which is arranged proximate to a surface to be treated of a manufactured article and is provided laterally with at least one passage opening which is directed toward the surface to be treated and is closed, at least partially, by a partition which is permeable to said powder particles.

33. The method of claim 32, wherein said mixture which passes through said duct has imposed fluid dynamics conditions of motion adapted to create, proximate to the surface of said partition directed toward the inside of said duct, a preset speed range as a function of the physical characteristics of said powder particles.

34. The method of claim 33, wherein the speed range is of a turbulent type.

35. The method of claim 33, wherein the speed range is adapted to establish, proximate to a surface of said permeable partition which is directed toward an inside region of said duct, a laminar boundary layer whose thickness is substantially equal to the average particle size of said powder particles.

36. The method of claim 35, wherein said mixture has an imposed fluid dynamics condition of motion within said conveyance channel with a Reynolds number ranging substantially from 10³ to 5×10⁴.

37. The method of claim 36, comprising providing the surface of said partition directed toward the inside of said duct and/or the inside wall of said duct, at least locally, with a controlled surface roughness.

38. The method of claim 37, wherein said controlled surface roughness is provided to have a value comprised substantially in a range from Ra 0.1 μm to Ra 100 μm.

39. The method of claim 38, comprising providing electrostatic charging of said mixture by triboelectric effect.

40. The method of claim 39, comprising providing electrostatic charging of said mixture by corona effect.

41. The method of claim 40, comprising providing application, by way of an auxiliary electrical source, an electrical field which has lines of force which are incident to the surface to be treated.
